(19) United States
(12) Patent Application Publication
(10) Pub. No.: US 2002/0106040 A1
(43) Pub. Date: Aug. 8, 2002

(54) Method and apparatus for reducing multipath distortion in a wireless ian system

(75) Inventors: Robert Conrad Malkemes, Bricktown, NJ (US); Gopal Triplicane Venkatesan, Plainsboro, NJ (US); Charles Reed JR., Yardley, PA (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 09/776,078

(22) Filed: Feb. 2, 2001

(51) Int. Cl. H04L 1/02

(52) U.S. Cl. 375/347; 375/350

(57) ABSTRACT

A spatial diversity combiner comprises a plurality of feed forward equalizers (FFEs), a decision feedback equalizer (DFE), and a tap control circuit. The plurality of FFEs receive spatially diverse replicas of an RF signal and optimally combine them. The DFE provides feedback for tap weight control and optimal equalization of the transmission channel. Symbol error is generated by a slicer circuit or by a maximum likelihood sequence estimation (MLSE) process.

The invention generally relates to equalizers and, more particularly, the invention relates to a method and apparatus for adaptive spatial equalization of a channel in a wireless local area network (LAN) system.

### BACKGROUND OF THE INVENTION

In a radio frequency (RF) transmission channel, a transmitted signal experiences time dispersion due to a deviation in the channel frequency response from the ideal channel characteristics of a constant amplitude and linear phase (constant delay) response. These non-ideal channel characteristics mainly result from multipath distortion, that is, the transmitted signal can take more than one path in the transmission channel. If at least two paths have a time difference exceeding the distance between two symbols transmitted in succession, a symbol on one of these paths will interfere with a following symbol on another, shorter path. This can result in signal fade and intersymbol interference (ISI).

Consequently, to achieve optimal demodulation of an RF signal, an equalizer is required in the receiver system to compensate for the non-ideal channel characteristics by using adaptive filtering. By correcting the amplitude and phase response of the received signal, the equalizer minimizes the ISI of the received signal, thus improving the signal detection accuracy.

Non-ideal channel characteristics are particularly problematic during reception of RF signals transmitted by wireless local area networks (LANs). Transmitting an RF signal over a wireless LAN introduces additional random dynamics on the amplitude and phase response of the channel, due in part to the motion of the users. High Doppler frequency, flat and frequency selective fading, and shadowing are the most common dominant factors that decrease receiver performance.

Therefore, there exists a need in the art for a method and apparatus for reducing multipath distortion in a wireless LAN transmission channel.

### SUMMARY OF THE INVENTION

The disadvantages associated with the prior art are overcome by a method and apparatus for reducing multipath distortion in an RF signal comprising a spatial diversity combiner. The spatial diversity combiner combats multipath distortion by gathering 2 or more spatially diverse replicas of an RF signal and combining them in an optimal way using a plurality of feed forward equalizers. The spatial combiner also simultaneously performs temporal equalization to reduce or eliminate inter-symbol interference via a decision feedback equalization process. The spatial diversity combiner of the present invention can equalize a dynamically changing channel of the type experienced in high data rate wireless LANs.

### BRIEF DESCRIPTION OF THE DRAWINGS

The teachings of the present invention can be readily understood by considering the following detailed description in conjunction with the accompanying drawings, in which:

FIG. 1 depicts a block diagram of a receiver having a spatial diversity combiner of the present invention;

FIG. 2 depicts a detailed block diagram of one embodiment of the spatial diversity combiner;

FIG. 3 depicts a detailed block diagram of a second embodiment of the spatial diversity combiner.

To facilitate understanding, identical reference numerals have been used, where possible, to designate identical elements that are common to the figures.

### DETAILED DESCRIPTION

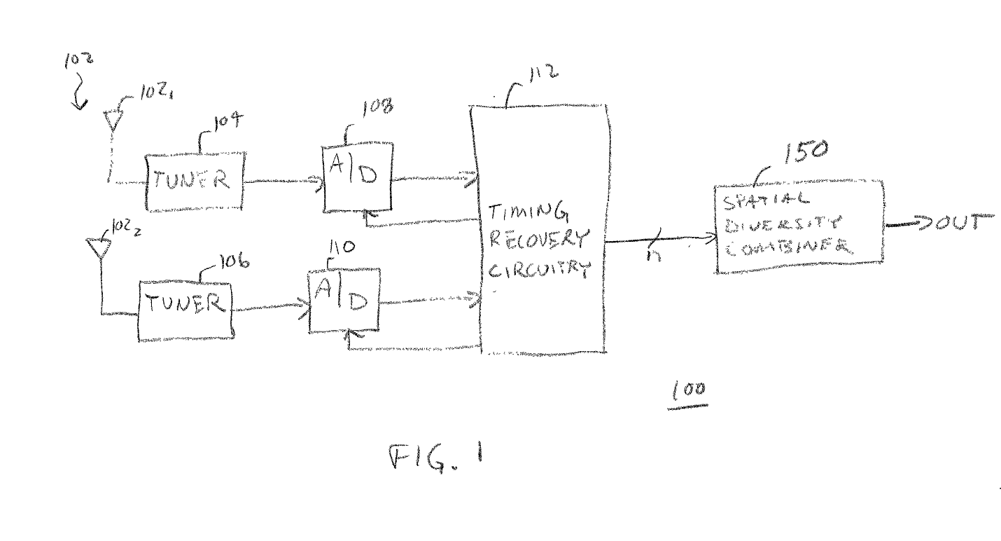

FIG. 1 depicts a block diagram of a receiver 100 that uses a spatial diversity combiner 150 to combat multipath distortion. In the present embodiment of the invention, the receiver is capable of receiving RF signals in the 5 GHz wireless band. The 5 GHz wireless band is the typical band used with short-range, high-speed wireless LANs used in home or office-like environments. The signal modulation used in such a system is typically 64 and/or 256 QAM. The symbol rate is 5 megasymbols/second. Although the present invention is described for use with a 5 GHz wireless LAN, it is known to those skilled in the art that the present invention could be adapted for use in other frequency bands.

Antennas 102₁ and 102₂ (collectively antennas 102) receive spatially diverse replicas of an RF signal transmitted, for example, over a 5 GHz wireless LAN. Although the present invention is described using two antennas, it is known by those skilled in the art that N antennas can be used. Each antenna 102₁ and 102₂ is respectively coupled to tuners 104 and 106. The tuners 104 and 106 filter and downconvert the received signal to near baseband. The near baseband signals are respectively coupled to the analog-to-digital (A/D) converters 108 and 110. The digitized signals are applied to the joint timing recovery circuitry 112. The timing recovery circuitry 112 generates a signal at the symbol rate fₛ and synchronizes this signal to the best estimate of the transmitted data and then identifies symbol timing information for decoding and synchronization purposes.

The samples are then coupled to the spatial diversity combiner 150. The most difficult class of problems associated with this 5 GHz band is that of multipath. In this frequency band and in a home or SOHO environment, the multipath takes on a broad range of characteristics including frequency flat fading, frequency selective fading and Doppler distortion. To combat this set of problems, a multiple antenna diversity technique is used to form a spatial diversity equalizer/combiner. At least two antenna inputs are equalized and combined to reduce the effects of multipath encountered in the home or home/office environments.

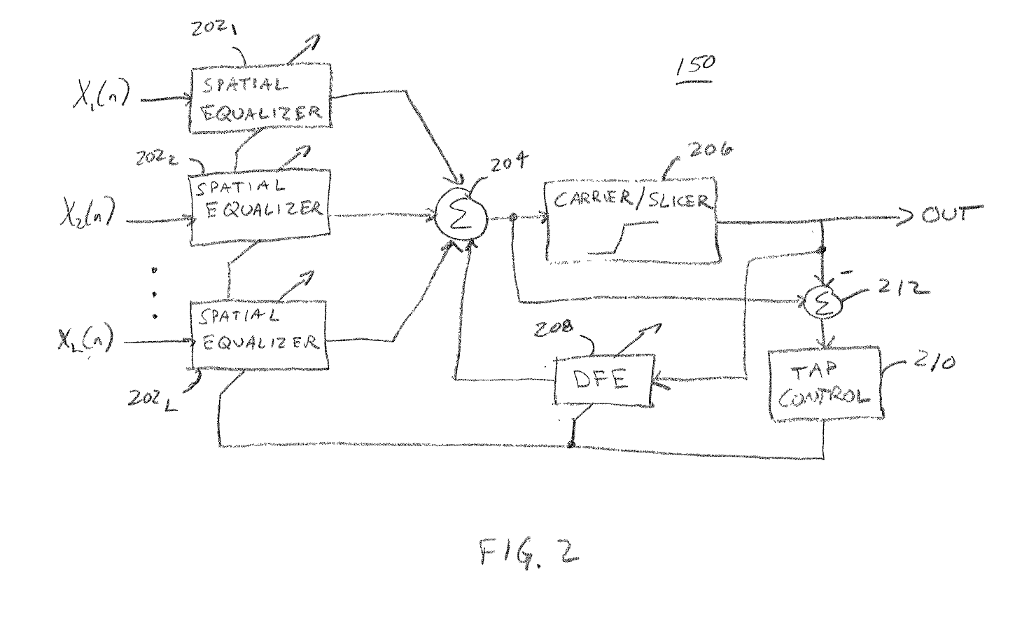

FIG. 2 depicts a detailed block diagram of an embodiment of the spatial diversity combiner 150. The spatial diversity combiner 150 comprises a plurality of spatial equalizers 202. These equalizers are multi-tap feed forward equalizers (FFEs) that delay their respective signals to achieve equal delays in the received signals on a symbol spaced basis. Once spatially equalized by equalizers 202, the signals are combined in combiner 204. The output of the combiner 204 is coupled to a single circuit 206 comprising both carrier loop recovery circuit and a slicer.

The carrier/slicer circuit 206 comprises a carrier recovery loop that extracts the carrier from the equalized symbols and a slicer circuit that samples the symbols to generate estimated symbols. The carrier recovery loop is used to correct for any frequency or phase offset in the received signal, thus mitigating some of the Doppler effects. The output of the carrier/slicer circuit 206 is coupled to the DFE 208 for temporal equalization and the removal of intersymbol interference. The output of the DFE 208 is coupled back to the combiner 204. The slicer in the carrier/slicer circuit 206 and subtractor 212 are used to produce a symbol error that is coupled to the tap control 210, that is, the slicer together with the subtractor 212 compares the estimated symbol sample with the closes known symbol and generates an error signal. The tap control 210 uses the error signal to produce tap weight adjustments for all the equalizers: the spatial equalizers ²⁰²₁-202_{L} and the DFE 208. The operation of the tap control 210 is discussed below.

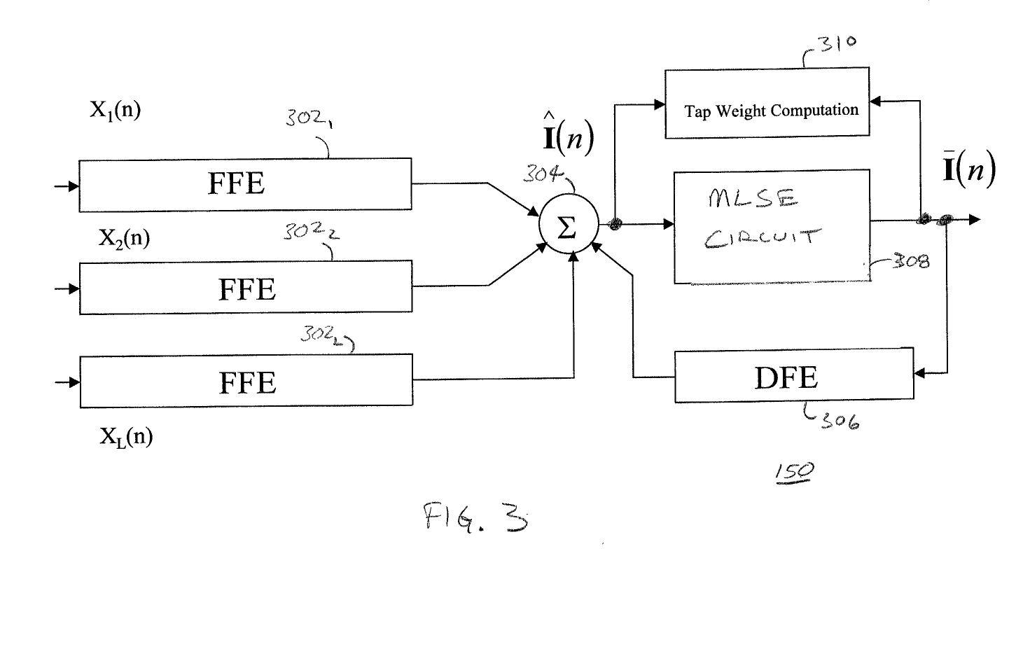

FIG. 3 depicts a block diagram of a second embodiment of the spatial diversity combiner 150. In the second embodiment, the spatial diversity combiner 150 comprises N feed forward equalizers 302, a combiner 304, a DFE 306, a maximum likelihood sequence estimation (MLSE) circuit 308, and a tap control circuit 310. Each of the FFE equalizers 302 receives a spatially diverse replica of the transmitted RF signal in sampled, near-baseband form. The number of taps included within each FFE 302 is determined by the maximum length of delay encountered by the replicas of the RF signal that are simultaneously received. The total length of each FFE 302 must span the entire length of the multipath signals (i.e., the spatially diverse replicas of the RF signal).

The output of each FFE 302 comprises an appropriately delayed replica of the RF signal. The combiner 304 combines each delayed replica with the output of the DFE 306. The output of the combiner 304 is coupled to the MLSE circuit 308 and to the tap control circuit 310. The tap control circuit 310 uses both the output of the combiner 304 and the output of the MLSE circuit 308 to compute the taps of the FFEs 302 and the DFE 306.

The MLSE circuit 308 makes an improved estimate of the output symbol decision based upon knowledge of the channel coding used. Maximum Likelihood Sequence Estimation, or MLSE, is used to improve the prediction of received symbols by including the trellis, or Viterbi, decoding operation before the DFE 306. The added complexity of this additional circuitry is warranted by the improvement in bit error rate (BER) and improved carrier-to-interference performance for the spatial diversity combiner 150. The level of performance is generally on the order of a few dB in BER performance. A convolution code is used in this system as the inner code making it appropriate for MLSE.

Referring to both FIGS. 2 and 3, the spatial diversity combiner 150 performs blind equalization and, thus, does not require a training sequence embedded in the RF signal to aid in adjusting the taps. The general operation of the spatial diversity combiner 150 is governed by the following set of equations:

C_{f}(n+1)=C_{f}(n)+μ·ε(n)·X*(n) Eq. 1

C_{b}(n+1)=C_{b}(n)+μ·ε(n)·I*(n) Eq. 2

where C_{f}(n) is the tap weight matrix for the FFE 202 or 302, X*(n) is the input signal matrix for the L input FFEs, and C_{b}(n) is the vector feedback tap weights for the DFE 208 or 306. The symbol ensemble of all possible symbols is given by I(n). As shown in FIGS. 2 and 3, the output of the combiner 204 or 304 is the symbol ensemble estimates Î(n). Given the symbol ensemble estimates, the error ε(n)=I(n)−Î(n) is derived and used to adjust the taps in accordance with Equations 1 and 2. The calculations are performed on a stepwise basis quantified by the value μ. A lower overall symbol error rate (SER) can be achieved with a smaller step size. A larger step size, however, will enable a faster convergence rate. For dynamically changing systems, such as a high-speed wireless LAN system, it is desirable to use adaptive step size techniques and optimal cost functions to achieve quick convergence while maintaining a low SER.

Although various embodiments which incorporate the teachings of the present invention have been shown and described in detail herein, those skilled in the art can readily devise many other varied embodiments that still incorporate these teachings.

What is claimed is:

1. An apparatus for receiving an radio frequency (RF) signal comprising:
a plurality of antennas for receiving spatially diverse replicas of the RF signal;
a tuner coupled to each antenna for selecting the RF signal from a frequency band;
a spatial diversity combiner having said spatially diverse replicas of the RF signal as inputs, wherein said spatial diversity combiner adaptively combines said spatially diverse replicas of the RF signal to generate an equalized RF signal.

2. The apparatus of claim 1 wherein said spatial diversity combiner comprises:
a plurality of feed forward equalizers;
a combiner for combining the output signals from each of said plurality of feed forward equalizers to form a combined signal;
a carrier/slicer circuit for extracting the carrier from the combined signal and generating a symbol error signal;
a decision feedback equalizer for suppressing inter-symbol interference in said combined signal; and
a tap control circuit for adjusting the tap weights of said plurality of feed forward equalizers and said decision feedback equalizer using said symbol error signal.

3. The apparatus of claim 1 wherein said spatial diversity combiner comprises:
a plurality of feed forward equalizers;
a combiner for combining the output signals from each of said plurality of feed forward equalizers to form a combined signal;
a maximum likelihood sequence estimation (MLSE) circuit generating a symbol error signal from said combined signal;
a decision feedback equalizer for suppressing inter-symbol interference in said combined signal; and
a tap control circuit for adjusting the tap weights of said plurality of feed forward equalizers and said decision feedback equalizer using said symbol error signal.

4. The apparatus of claim 1 wherein said frequency band comprises a 5 GHz frequency band.

5. A method of receiving a radio frequency (RF) signal comprising:
receiving a plurality of spatially diverse replicas of the RF signal;
adaptively combining said plurality of spatially diverse replicas to generate an equalized RF signal.

6. The method of claim 5 wherein said combining step further comprises:
spatially equalizing each of said plurality of spatially diverse replicas;
combining said spatially equalized replicas to generate a combined signal;
generating a symbol error signal from said combined signal using a symbol slicer;
temporally equalizing said combined signal using a decision feedback equalizer; and
adapting said spatial equalizing and said temporal equalizing steps to said symbol error signal.

7. The method of claim 5 wherein said combining step further comprises:
spatially equalizing each of said plurality of spatially diverse replicas;
combining said spatially equalized replicas to generate a combined signal;
generating a symbol error signal from said combined signal using a maximum likelihood sequence estimation process;
temporally equalizing said combined signal using a decision feedback equalizer; and
adapting said spatial equalizing and said temporal equalizing steps to said symbol error signal.

8. An apparatus for equalizing a radio frequency (RF) signal comprising:
a plurality of feed forward equalizers;
a combiner for combining the output signals from each of said plurality of feed forward equalizers to form a combined signal;
a symbol error circuit for generating a symbol error signal;
a decision feedback equalizer for suppressing inter-symbol interference in said combined signal; and
a tap control circuit for adjusting the tap weights of said plurality of feed forward equalizers and said decision feedback equalizer using said symbol error signal.

9. The apparatus of claim 8 wherein said symbol error circuit comprises a symbol slicer circuit.

10. The apparatus of claim 8 wherein said symbol error circuit comprises a maximum likelihood sequence estimation (MLSE) circuit.
